(19) United States
(12) Patent Application Publication
(10) Pub. No.: US 2026/0006092 A1
(43) Pub. Date: Jan. 1, 2026

(54) DISTRIBUTED PROCESSING SYSTEM, DISTRIBUTED PROCESSING METHOD, AND PROGRAM

(71) Applicant: NTT. Inc., Tokyo (JP)

(72) Inventors: Yurika SUGA, Musashino-shi, Tokyo (JP); Yoshihide Nakagawa, Musashino-shi, Tokyo (JP)

(21) Appl. No.: 18/880,603

(22) PCT Filed: Jul. 6, 2022
(86) PCT No.: PCT/JP2022/026805

§ 371 Date: Jan. 2, 2025

(51) Int. Cl. H04L 67/1004; H04L 9/08; H04L 9/32

(52) U.S. Cl. CPC H04L 67/1004; H04L 9/0894; H04L 9/3263

(57) ABSTRACT

A distributed processing system (100) includes at least one master node (10) and a plurality of worker nodes (30) including operation resources for executing processing according to an instruction of the master node. The master node includes a device information collection unit (13) that collects device information of each of the worker nodes, a device information transmission unit (15) that transmits to at least one of the plurality of worker nodes device information of the other worker nodes and a processing distribution unit (17) that distributes processing to at least one of the plurality of worker nodes. The worker node includes a processing execution unit (60) that executes the processing distributed from the master node, and a processing sharing request unit (36) that requests at least one of the other worker nodes including the same type of an operation resource (a protection region (61), a FPGA (62), or the like) to share the processing based on the device information of the other worker nodes when the processing distributed from the master node is excessively increased.

### TECHNICAL FIELD

The present invention relates to a distributed processing system, a distributed processing method, and a program.

### BACKGROUND ART

Conventionally, there is a distributed processing system in which a master node collects device information such as presence or absence of a protection region (Enclave) from a plurality of worker nodes in advance, and when the master node receives a processing instruction from a user, the master node selects which worker node to execute processing on the basis of the collected device information and distributes the processing thereto (see, for example, Non Patent Literature 1).

### CITATION LIST

### Non Patent Literature

Non Patent Literature 1: Vaucher, S. et al. “SGX-Aware Container Orchestration for Heterogeneous Clusters.” 2018 IEEE 38th International Conference on Distributed Computing Systems (ICDCS) (2018): 730-741.

### SUMMARY OF INVENTION

### Technical Problem

In the distributed processing system, the master node may distribute not only processing that needs operation in the protection region but also processing that needs operation in hardware such as a field programmable gate array (FPGA). In this case, the master node also collects device information regarding the presence or absence of a hardware such as FPGA as well as the protection region from a plurality of worker nodes, but at that time, the following problem occurs.

The first problem is that, when there are many pieces of processing that need both the protection region and the FPGA, the processing is concentrated on a worker node including both the protection region and the FPGA.

The second problem is that only the master node has device information such as a protection region and an FPGA and the master node selects a worker node to execute processing based on the device information. The device information is not shared by worker nodes, and thus, the worker nodes are not able to confirm authenticity of devices (operation resource) such as an FPGA or a protection region in other worker nodes.

The present invention has been made to solve the above-described problems, and a main object thereof is to provide a distributed processing system, a distributed processing method, and a program capable of reducing bias in processing allocation to a plurality of worker nodes.

### Solution to Problem

A distributed processing system according to the present invention includes at least one master node, and a plurality of worker nodes including operation resources for executing processing according to an instruction of the master node, in which the master node includes a device information collection unit that collects device information of each of the worker nodes, a device information transmission unit that transmits to at least one of the plurality of worker nodes device information of the other worker nodes and a processing distribution unit that distributes processing to at least one of the plurality of worker nodes, and the worker nodes each include a processing execution unit that executes the processing distributed from the master node, and a processing sharing request unit that requests at least one of the other worker nodes including a same type of an operation resource to share the processing based on the device information of the other worker nodes when the processing distributed from the master node is excessively increased.

### Advantageous Effects of Invention

According to the present invention, it is possible to reduce bias in processing allocation to a plurality of worker nodes.

### BRIEF DESCRIPTION OF DRAWINGS

FIG. 1 is a schematic configuration diagram of a distributed processing system according to an embodiment.

FIG. 2 is an operation explanatory diagram at a time of device information collection of the distributed processing system according to the embodiment.

FIG. 3 is an operation explanatory diagram at a time of processing distribution of the distributed processing system according to the embodiment.

FIG. 4 is an explanatory diagram at a time of address confirmation among worker nodes of the distributed processing system according to the embodiment.

FIG. 5 is an explanatory diagram at the time of device information collection of the distributed processing system according to the embodiment.

FIG. 6 is a sequence diagram at the time of device information collection of the distributed processing system according to the embodiment.

FIG. 7 is an explanatory diagram at a time of device information sharing among the worker nodes of the distributed processing system according to the embodiment.

FIG. 8 is an explanatory diagram at the time of device information sharing among the worker nodes of the distributed processing system according to the embodiment.

FIG. 9 is a sequence diagram at the time of device information sharing among the worker nodes of the distributed processing system according to the embodiment.

FIG. 10 is an explanatory diagram at the time of processing distribution of the distributed processing system according to the embodiment.

FIG. 11 is a sequence diagram at the time of processing distribution of the distributed processing system according to the embodiment.

FIG. 12 is a hardware configuration diagram illustrating an example of a computer that implements functions of a master node and a worker node according to the embodiment.

### DESCRIPTION OF EMBODIMENTS

Hereinafter, embodiments of the present invention (hereinafter, referred to as “the present embodiments”) will be described in detail with reference to the drawings. Note that the drawings are only schematically illustrated to the extent that the present invention can be sufficiently understood. Therefore, the present invention is not limited to the illustrated examples. Furthermore, in the drawings, the same reference signs are given to common components and similar components, and duplicate description thereof will be omitted.

The present embodiment provides a distributed processing system that distributes and uses arithmetic processing in a protection region (Enclave), arithmetic processing in a hardware device such as a field programmable gate array (FPGA), and security resources such as keys among a plurality of host computers.

### Configuration of Distributed Processing System

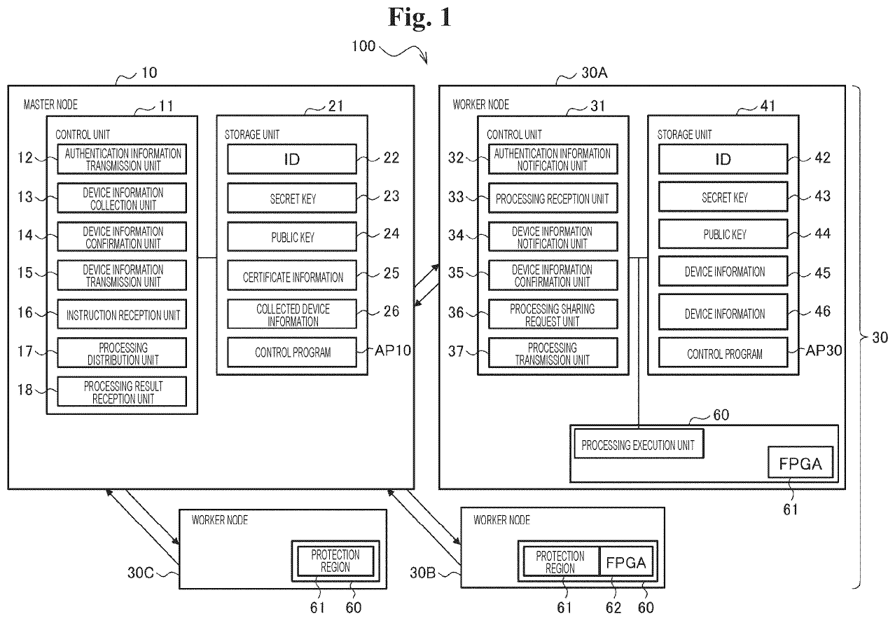

Hereinafter, a configuration of a distributed processing system according to the present embodiment will be described with reference to FIG. 1. FIG. 1 is a schematic configuration diagram of a distributed processing system 100 according to the present embodiment.

As illustrated in FIG. 1, the distributed processing system 100 according to the present embodiment includes at least one master node 10 and a plurality of worker nodes 30A, 30B, and 30C. Here, three worker nodes 30A, 30B, and 30C will be described as an example of the worker node. The master node 10 is communicably connected to each of the worker nodes 30A, 30B, and 30C via a network (not illustrated). Further, the worker nodes 30A, 30B, and 30C are also communicably connected to each other via a network (not illustrated).

The master node 10 is a server that instructs the worker nodes 30A, 30B, and 30C to execute processing. The master node 10 includes a control unit 11 and a storage unit 21.

The control unit 11 is embodied by a central processing unit (CPU) (not illustrated) of the master node 10 executing a control program AP10 stored in the storage unit 21 in advance. The control unit 11 further functions as an authentication information transmission unit 12, a device information collection unit 13, a device information confirmation unit 14, a device information transmission unit 15, an instruction reception unit 16, a processing distribution unit 17, and a processing result reception unit 18.

The authentication information transmission unit 12 is a unit that transmits information (authentication information) used for authentication in the worker nodes 30A to 30C to the worker nodes 30A to 30C. The device information collection unit 13 is a unit that collects device information of each of the worker nodes 30A to 30C. Here, the description will be given on a case where the device information indicates a configuration of a processing execution unit 60 of the worker nodes 30A to 30C. The device information confirmation unit 14 is a unit that confirms the device information of the worker nodes 30A to 30C. The device information transmission unit 15 is a unit that transmits device information of the worker nodes to the worker nodes 30A to 30C including the same type of the protection unit or FPGA based on the collected device information (collected device information 26). Note that this is an example, and the device information transmission unit 15 may transmit the device information of another worker node to each of the worker nodes 30A to 30C, and is not limited thereto. The instruction reception unit 16 is a unit that receives a processing execution instruction from an outside (for example, a terminal device operated by a user). The processing distribution unit 17 is a unit that distributes processing for which a processing execution instruction has been received from the outside to any of the plurality of worker nodes 30A to 30C. The processing result reception unit 18 is a unit that receives a processing result from each of the worker nodes 30A to 30C.

The storage unit 21 stores an ID 22, a secret key 23, a public key 24, certificate information 25, collected device information 26, and a control program AP10.

The ID 22 is number information unique to the master node 10. The secret key 23 is key information used when the encrypted data is decrypted. The secret key 23 is embedded, for example, at a time of manufacturing and is concealed from other devices. The public key 24 is key information used when communication is encrypted. The public key 24 is information paired with the secret key 23 and is used for decrypting information encrypted by the secret key 23. The public key 24 is disclosed to another device. The certificate information 25 is issued from a trusted third party and is information that guarantees the authenticity of the worker node. The collected device information 26 is device information collected by the master node 10 from each worker node 30. The control program AP10 is a program for causing a computer to function as the master node 10.

The worker node 30A is a server that executes processing in accordance with an instruction from the master node 10. The worker node 30A includes a control unit 31, a storage unit 41, and a processing execution unit 60. Note that, although not illustrated, the worker nodes 30B and 30C are configured similarly to the worker node 30A.

The control unit 31 is embodied by a CPU (not illustrated) of the worker node 30A executing a control program AP30 stored in advance in the storage unit 41. The control unit 31 functions as an authentication information notification unit 32, a processing reception unit 33, a device information notification unit 34, a device information confirmation unit 35, a processing sharing request unit 36, and a processing transmission unit 37.

The authentication information notification unit 32 is a unit that gives a notification of an authentication result in the worker node 30A. The processing reception unit 33 is a unit that receives processing from the master node 10 and the other worker nodes 30B and 30C. The device information notification unit 34 is a unit that notifies the master node 10 and the other worker nodes 30B and 30C of its own device information. The device information confirmation unit 35 is a unit that confirms the device information of the other worker nodes 30B and 30C. The processing sharing request unit 36 is a unit that requests at least one of the other worker nodes including the same type of an operation resource to share the processing based on the device information of the other worker nodes 30B and 30C sent from the master node 10 when the processing distributed from the master node 10 is excessively increased. The processing transmission unit 37 is a unit that transmits information regarding processing. Examples of the information regarding processing include a result of execution of the processing distributed from the master node 10 (completion of the processing), a request issued when a part of the processing distributed from the master node 10 is requested to be shared with other worker nodes 30B and 30C (a processing sharing request), and a notification to the master node 10 of a request for the other worker nodes 30B and 30C to share a part of the processing (a processing sharing request notification).

The storage unit 41 stores an ID 42, a secret key 43, a public key 44, own device information 45, device information 46 of other worker nodes, and a control program AP30.

The ID 42 is number information unique to the worker node 30. The secret key 43 is key information used when the encrypted data is decrypted. The secret key 43 is embedded, for example, at the time of manufacturing and is concealed from other devices. The public key 44 is key information used when communication is encrypted. The public key 24 is disclosed to another device. The device information 45 is own device information. The device information 46 is device information of other worker nodes. The control program AP30 is a program for causing a computer to function as the worker node 30.

The processing execution unit 60 is an arithmetic unit that executes processing distributed from the master node 10. The processing execution unit 60 executes, for example, processing that depends on a hardware device (hereinafter, it may be referred to as “device dependent processing”).

Among the worker nodes 30A to 30C, the control unit 31 and the storage unit 41 have a similar configuration, but the configuration of the processing execution unit 60 is different among the worker nodes 30A to 30C. The worker node 30A includes a protection region 61 in the processing execution unit 60. The worker node 30B includes the protection region 61 and an FPGA 62 in the processing execution unit 60. The worker node 30C includes the FPGA 62 in the processing execution unit 60.

Here, the “protection region” refers to a region that is separated by software by a system management function of an operating system (OS) or the like, where communication from a service application outside the protection region is only possible using a specific application programming interface (API), and the independence of internal data is guaranteed.

Further, a “field programmable gate array (FPGA)” is a type of programmable logic device (PLD) that can change and redefine the structure of a logic circuit. The FPGA can be embodied by a hardware description language (HDL) according to the application of the FPGA. In the fields of audio and image signal processing and encryption, it may be possible to increase the calculation speed by 10 to 20 times as compared with a case where similar processing is performed by a general-purpose CPU.

Note that the worker node 30 may be configured to include other operation resources in the processing execution unit 60 instead of the protection region 61 or the FPGA 62, or in addition to the protection region 61 or the FPGA 62. Examples of other operation resources include a graphics processing unit (GPU) and the like. The GPU is a unit that performs calculation processing necessary for image depiction such as 3D graphics. The GPU may be able to increase the calculation speed several times to 100 times or more as compared with a case where similar processing is performed by a general-purpose CPU.

### Outline of Operation of Distributed Processing System

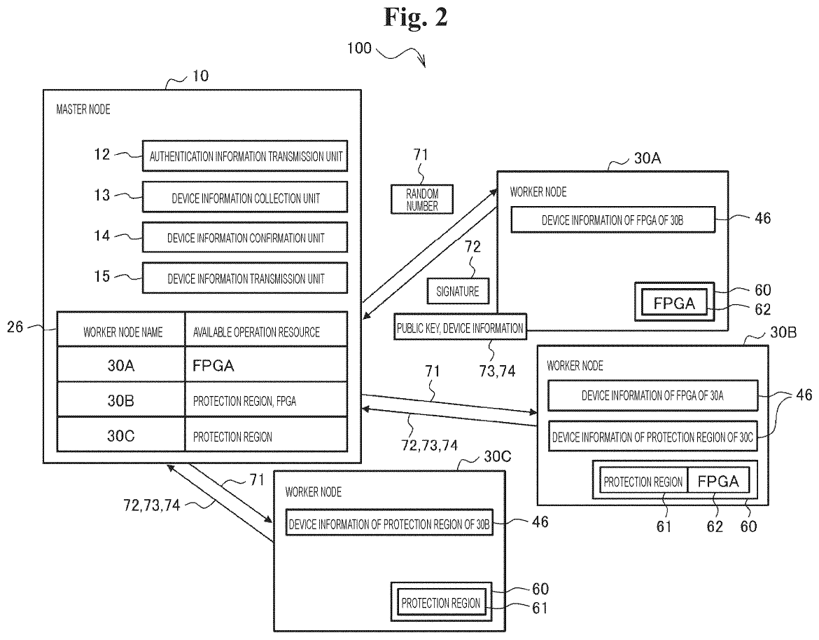

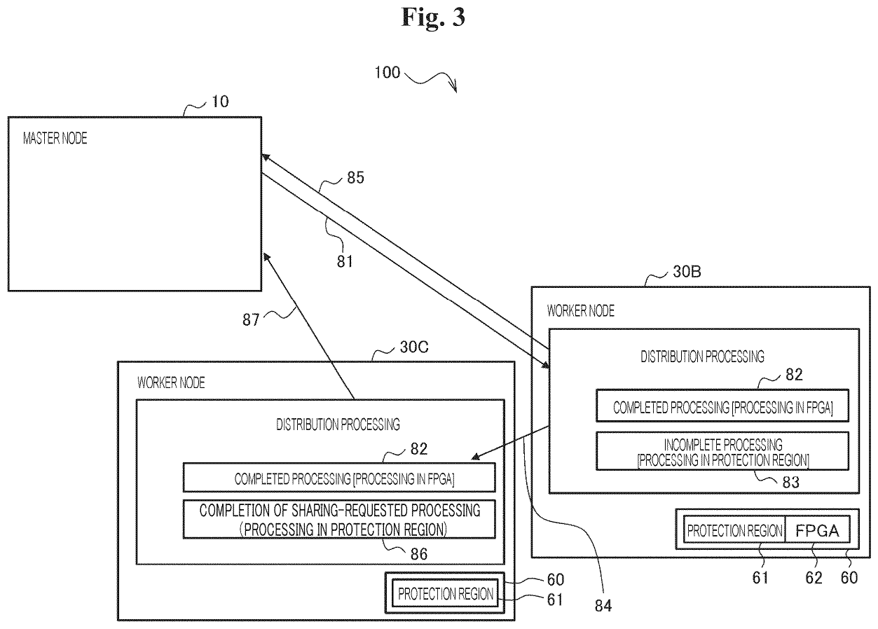

Hereinafter, an outline of an operation of the distributed processing system will be described with reference to FIGS. 2 and 3. FIG. 2 is an operation explanatory diagram at a time of device information collection of the distributed processing system 100. FIG. 3 is an operation explanatory diagram at a time of processing distribution of the distributed processing system 100.

As illustrated in FIGS. 2 and 3, in the present embodiment, the master node 10 and each worker node 30 perform the following processing.

(1) As illustrated in FIG. 2, first, the master node 10 performs device authentication of each worker node 30 and collects device information 74 of the processing execution unit 60 such as the presence or absence of the protection region 61 and the presence or absence of the FPGA 62. At that time, the authentication information transmission unit 12 in the master node 10 transmits a random number 71 to each worker node 30. In response to this, each worker node 30 sends a signature 72, a public key 73, and the device information 74 for the random number 71. The master node 10 performs device authentication of each worker node 30 by receiving the signature 72, the public key 73, and the device information 74 from the worker node 30. The master node 10 registers the collected device information 74 of each worker node 30 in the collected device information 26.

(2) Next, the master node 10 transmits to each worker node 30 the device information 46 of the other worker nodes 30 including the same type of operation resource based on the collected device information 26. Each worker node 30 stores the device information 46 of the other worker nodes transmitted from the master node 10 in the storage unit 41.

(3) Next, the master node 10 receives a processing execution instruction from the outside (for example, a terminal device operated by a user) at any timing. Then, the master node 10 distributes the processing to the worker nodes 30 including operation resources such as the protection region 61 and the FPGA 62 capable of executing the processing instructed by the processing execution instruction as illustrated in FIG. 3. Here, the description will be given on a case where the master node 10 sends distribution processing 81 to the worker node 30B including both the protection region 61 and the FPGA 62 in the processing execution unit 60.

(4) Next, if the processing distributed to a certain worker node 30 is excessively increased, the worker node 30 transmits a part of the processing to another worker node including the same type of operation resources. Here, the description will be given on a case where the worker node 30B has completed the execution of the processing in the FPGA 62 but has not completed the execution of the processing in the protection region 61 and requests the worker node 30C including the protection region 61 to share the incomplete processing. In this case, the worker node 30B transmits a request for sharing the incomplete processing (processing sharing request 84) to the worker node 30C.

The processing sharing request 84 includes information regarding completed processing 82 (for example, an execution result of processing in the FPGA 62) and information regarding incomplete processing 83 (for example, contents of incomplete processing in the protection region 61).

Further, the worker node 30B transmits to the master node 10 a notification (processing sharing request notification 85) indicating that the worker node 30C has been requested to share the incomplete processing. Thus, the master node 10 can recognize that the execution result of the processing distributed to the worker node 30B will be sent from the worker node 30C.

(5) Next, the worker node 30 (here, the worker node 30C) requested to share the incomplete processing executes the requested processing. When the execution of the requested processing is completed, the worker node 30C sends completion of distributed processing 87 to the master node 10. The completion of distributed processing 87 includes information regarding the completed processing 82 executed by the worker node 30B and information regarding completion of sharing-requested processing 86 executed by the worker node 30C. The information regarding the completed processing 82 is, for example, an execution result of processing performed in the FPGA 62 of the worker node 30B. The information regarding the completion of sharing-requested processing 86 is, for example, an execution result of processing performed in the protection region 61 of the worker node 30C itself. The master node 10 that has received the completion of distributed processing 87 sends the processing execution result to the terminal device (transmission source of the processing execution instruction) of the user based on the completion of distributed processing 87.

Such a distributed processing system 100 performs device authentication of the worker nodes 30A, 30B, and 30C in advance in the master node 10, sharing of device information in advance among the worker nodes 30A, 30B, and 30C, and aggregation of information in the master node 10. Thus, the distributed processing system 100 can confirm the authenticity of the protection region 61 and the FPGA 62 in the worker nodes 30 as the processing distribution destination. In addition, when the processing is biased to one or more than one of the worker nodes 30 (in the illustrated example, the worker node 30B) having many functions, that is, when the processing distributed from the master node 10 to the worker node 30B is excessively increased, the distributed processing system 100 can divide a part of the processing to the other worker nodes (in the illustrated example, the worker node 30C) having a smaller number of functions. As a result, the distributed processing system 100 can reduce the bias of the processing allocated to the plurality of worker nodes 30.

### Specific Example of Operation of Distributed Processing System

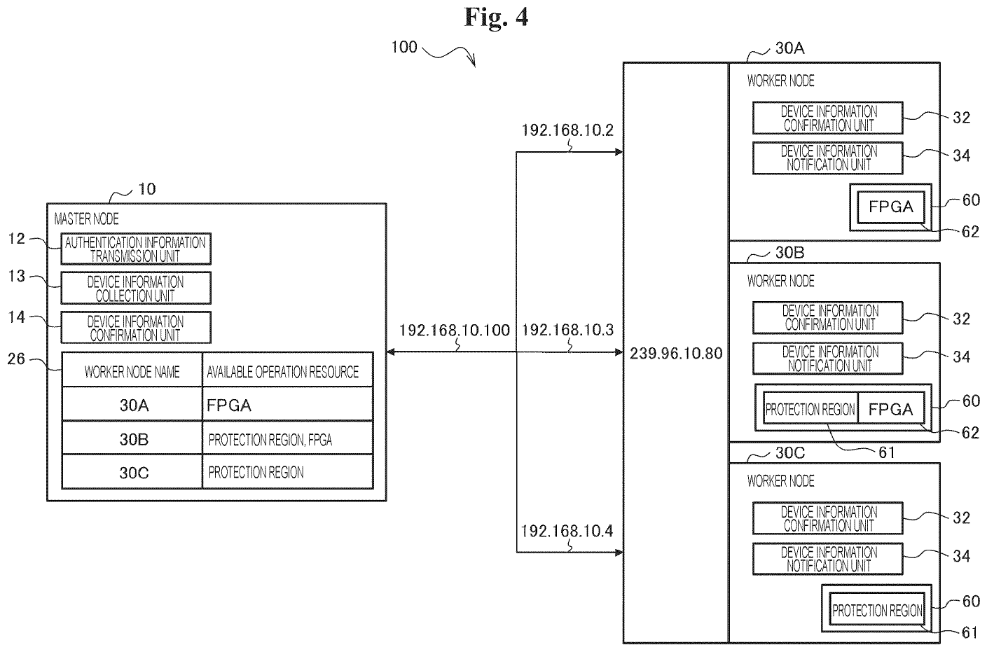

Hereinafter, a specific example of the operation of the distributed processing system will be described with reference to FIGS. 4 to 11. Each drawing mainly illustrates components of the master node 10 and the worker node 30 operating in each operation. Description will be given on a case where the number of the worker nodes 30 is three, which are, the worker nodes 30A, 30B, and 30C. However, the number of the worker nodes 30 is not limited to three.

As illustrated in FIG. 4, first, the distributed processing system 100 performs address confirmation among the worker nodes 30A, 30B, and 30C in advance. FIG. 4 is an explanatory diagram at a time of address confirmation among the worker nodes 30A, 30B, and 30C in the distributed processing system 100.

In the example illustrated in FIG. 4, as an example, an IP address of “192.168.10.100” is allocated to the master node 10. Further, an IP address of “192.168.10.2” is allocated to the worker node 30A. Further, an IP address of “192.168.10.3” is allocated to the worker node 30B. Further, an IP address of “192.168.10.4” is allocated to the worker node 30C.

The distributed processing system 100 operates as follows at the time of address confirmation among the worker nodes 30A, 30B, and 30C.

(1) The distributed processing system 100 causes a worker node group having calculation resources to participate in a specific multicast address (IP address).

(2) The master node 10 sends a request to each worker node 30 to confirm the presence of the worker nodes 30 that can provide calculation resources for the multicast address.

(3) The worker nodes 30A, 30B, and 30C send information for communication (IP address or the like) to the master node 10 in order to notify their existence.

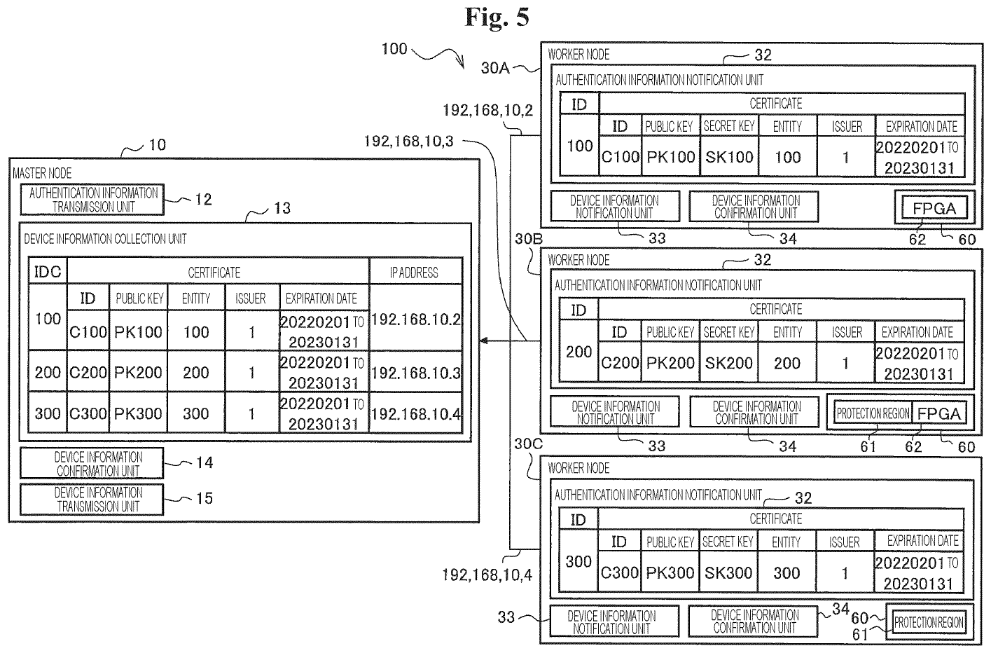

As illustrated in FIG. 5, in the distributed processing system 100, the master node 10 performs device authentication of the processing execution units 60 in the worker nodes 30A, 30B, and 30C in advance, and collects device information of the processing execution units 60. FIG. 5 is a diagram for explaining device information collection performed by the distributed processing system 100. In the example illustrated in FIG. 5, the worker nodes 30A, 30B, and 30C store ID information assigned thereto and certificate information issued from a trusted third party in the storage unit 41 (FIG. 1). The certificate information includes ID information, public key information, secret key information, entity information, issuer information, and expiration date information. The device information collection unit 13 of the master node 10 sends to the worker nodes 30A, 30B, and 30C a request for transmission of their device information to collect the device information of the worker nodes 30A, 30B, and 30C. The worker nodes 30A, 30B, and 30C transmit their device information to the master node 10 in response to the transmission request. Then, the device information collection unit 13 in the master node 10 registers the device information of the worker nodes 30A, 30B, and 30C in the collected device information 26 (FIG. 1).

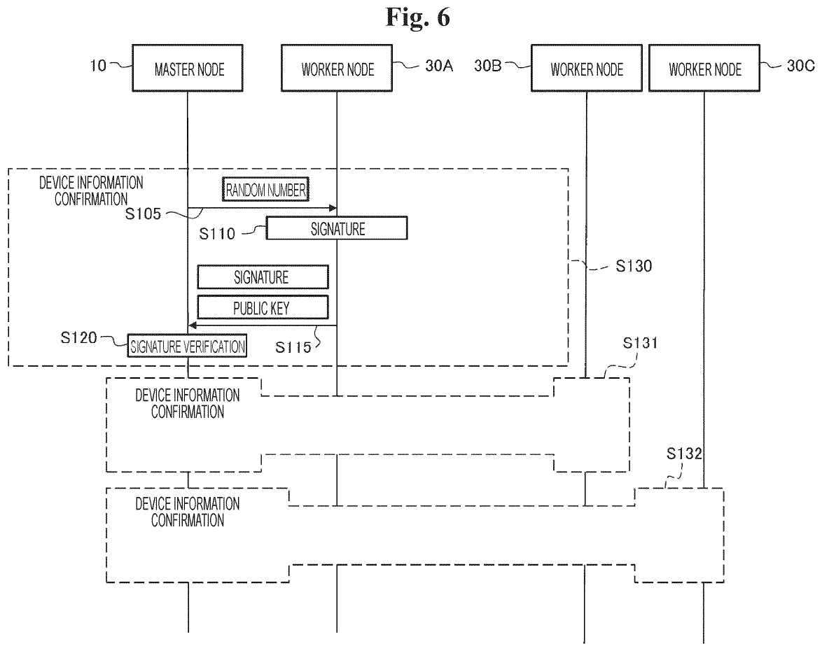

As illustrated in FIG. 6, the distributed processing system 100 operates as follows at the time of device information collection. FIG. 6 is a sequence diagram at the time of device information collection performed by the distributed processing system 100.

At the time of device information collection, the master node 10 performs device authentication of the processing execution units 60 of the worker nodes 30A, 30B, and 30C and collects device information. At that time, the master node 10 confirms the device information of the worker nodes 30A, 30B, and 30C as illustrated in FIG. 6. Here, a process where the master node 10 confirms the device information of the worker node 30A will be mainly described.

The master node 10 sends a random number to the worker node 30A (step S105). In response to this, the worker node 30A signs the random number by using the secret key information stored therein that is the input value generation source (step S110).

After step S110, the worker node 30A sends the signature and the public key information to the master node 10 (step S115). The public key information includes the device information of the processing execution unit 60 of the worker node 30A.

After step S115, the master node 10 signs a random number using the public key information received from the worker node 30A and verifies whether or not the signature matches the signature received from the worker node 30A, thereby confirming that the worker node 30A is a trusted partner (step S120). That is, the master node 10 performs device authentication of the processing execution unit 60 of the worker node 30A by a challenge response method. Hereinafter, the processing from step S105 to step S120 is referred to as step S130. By the processing of step S130, the master node 10 confirms the device information of the worker node 30A.

Hereinafter, the distributed processing system 100 performs processing of steps S131 and S132 on the other worker nodes 30B and 30C similarly to the processing of step S130 on the worker node 30A. Thus, the master node 10 confirms the device information of the worker nodes 30B and 30C.

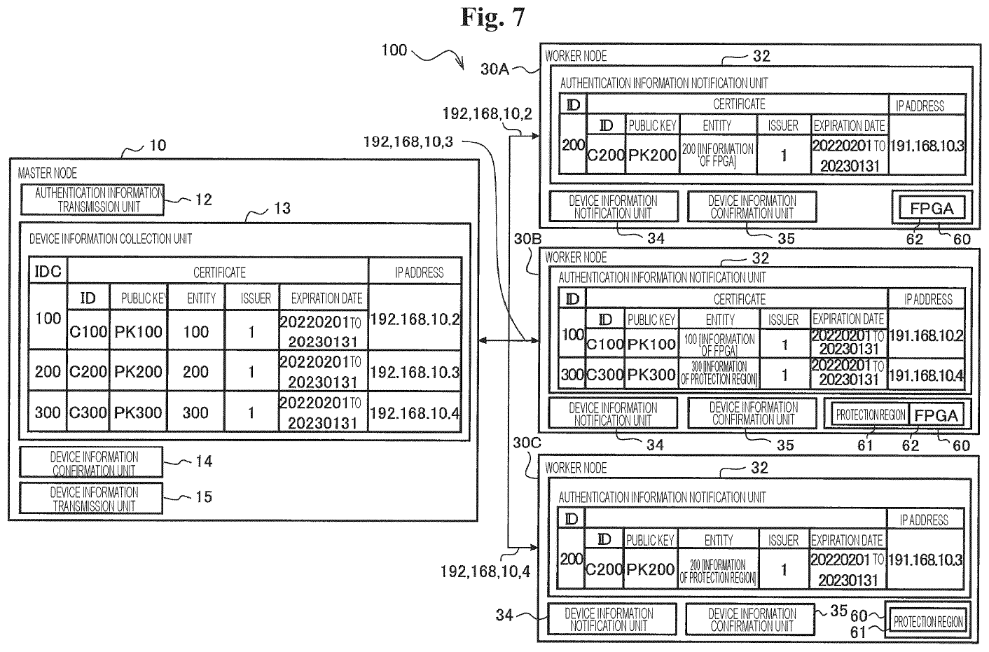

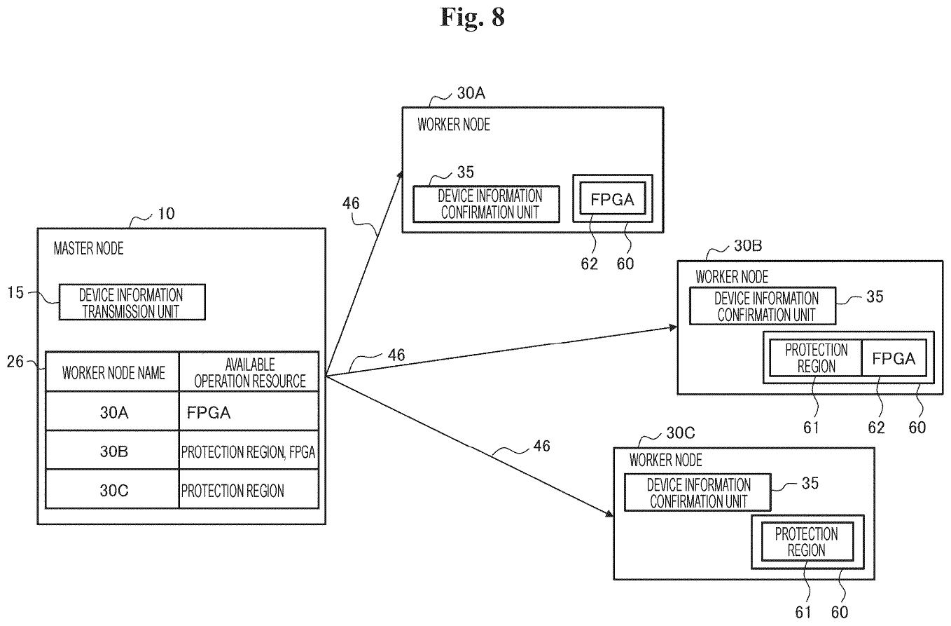

As illustrated in FIGS. 7 and 8, the distributed processing system 100 performs device information sharing among the worker nodes 30A, 30B, and 30C after collecting the device information. FIG. 7 is an explanatory diagram at a time of device information sharing among the worker nodes 30A, 30B, and 30C of the distributed processing system 100. FIG. 8 is an explanatory diagram at the time of device information sharing among the worker nodes 30A, 30B, and 30C of the distributed processing system 100.

As illustrated in FIGS. 7 and 8, the device information transmission unit 15 in the master node 10 transmits device information of a worker node to the other worker nodes 30 including the same type of operation resources based on the collected device information (the collected device information 26 (see FIG. 1)).

At this time, the device information transmission unit 15 in the master node 10 transmits device information of the FPGA 62 in the worker node 30B to the worker node 30A including the FPGA 62 as operation resources. Further, the device information transmission unit 15 in the master node 10 transmits the device information of the FPGA 62 in the worker node 30A and device information of the protection region 61 in the worker node 30C to the worker node 30B including the protection region 61 and the FPGA 62 as operation resources. Furthermore, the device information transmission unit 15 in the master node 10 transmits device information of the protection region 61 in the worker node 30B to the worker node 30C including the protection region 61 as an operation resource. Thus, the distributed processing system 100 can minimize the transmission amount of the device information and complete the transmission of the device information in a short time.

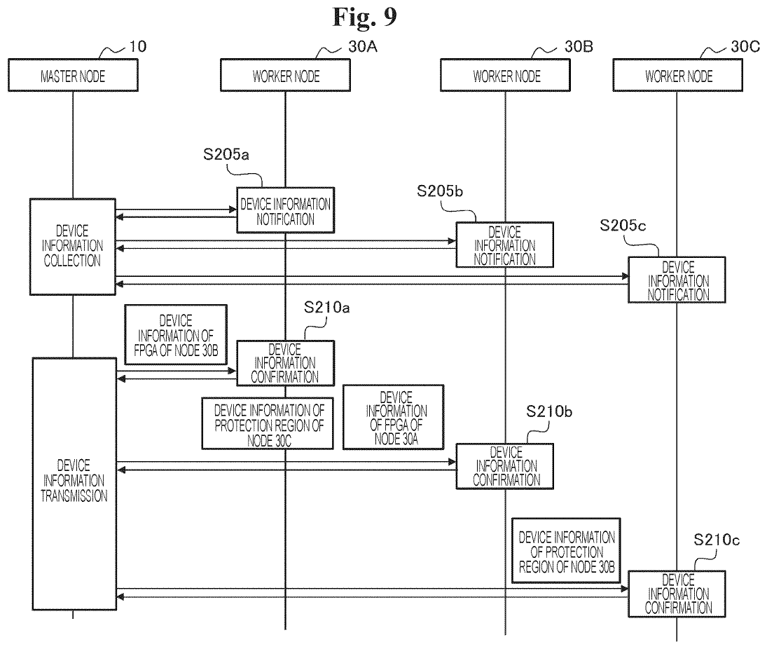

As illustrated in FIG. 9, the distributed processing system 100 operates as follows at the time of device information sharing among the worker nodes 30A, 30B, and 30C. FIG. 9 is a sequence diagram at the time of device information sharing among the worker nodes in the distributed processing system 100.

At the time of device information sharing among the worker nodes 30A, 30B, and 30C, the device information collection unit 13 in the master node 10 sends to the worker node 30A a request for transmission of the device information, and the worker node 30A notifies the master node 10 of the device information of the worker node 30A in response to the request (step S205a). Similarly, the master node 10 sends to the worker node 30B a request for transmission of the device information, and the worker node 30B notifies the master node 10 of the device information of the worker node 30B (step S205b). Similarly, a request for transmission of the device information is sent from the master node 10 to the worker node 30C, and the worker node 30C notifies the master node 10 of the device information of the worker node 30C (step S205c). Thus, the device information of the worker nodes 30A, 30B, and 30C is collected in the device information collection unit 13 as illustrated in FIG. 7.

Next, the device information transmission unit 15 in the master node 10 transmits the device information of the FPGA 62 of the worker node 30B to the worker node 30A including the FPGA 62 as an operation resource to let the worker node 30A have the device information of the worker node 30B (step S210a). Further, the device information transmission unit 15 of the master node 10 transmits the device information of the FPGA 62 of the worker node 30A and the device information of the protection region 61 of the worker node 30C to the worker node 30B including the protection region 61 and the FPGA 62 as operation resources to let the worker node 30B have the device information of the worker node 30A and the worker node 30C (step S210b). Furthermore, the device information transmission unit 15 of the master node 10 transmits the device information of the protection region 61 of the worker node 30B to the worker node 30C including the protection region 61 as an operation resource to let the worker node 30C have the device information of 30B (step S210c). By performing such processing, the distributed processing system 100 enables cooperation between the worker nodes 30 including the same type of operation resources.

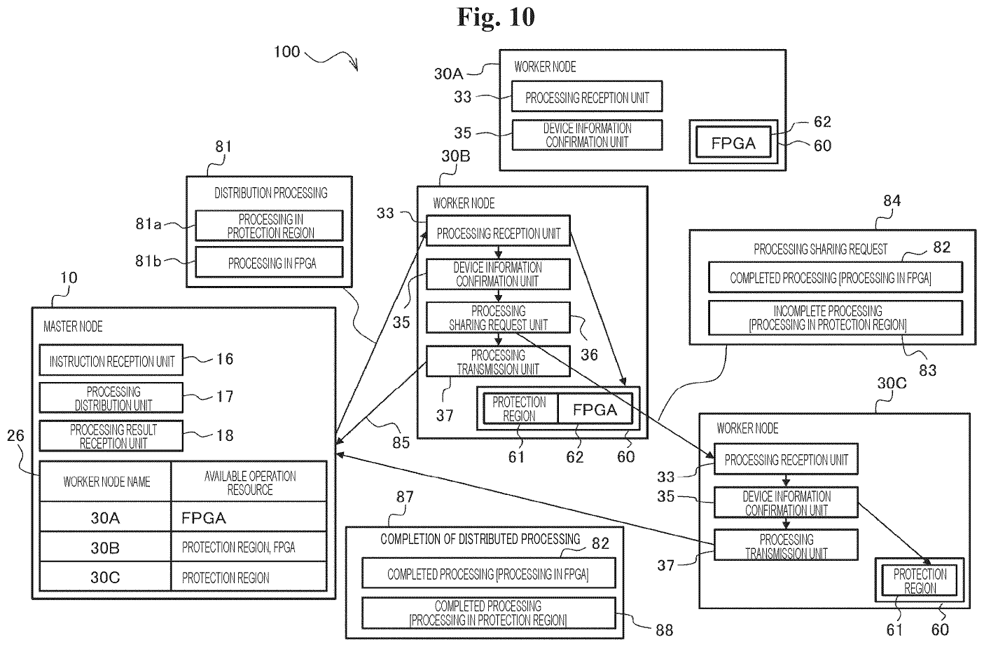

As illustrated in FIG. 10, the distributed processing system 100 performs processing distribution when receiving a processing execution instruction from the outside (for example, a terminal device operated by a user) at any timing. FIG. 10 is a diagram for explaining processing distribution performed by the distributed processing system 100.

The instruction reception unit 16 of the distributed processing system 100 receives a processing execution instruction from the outside (for example, a terminal device operated by a user) at any timing. Then, the processing distribution unit 17 of the distributed processing system 100 distributes the processing to the worker nodes 30 including an operation resource capable of executing the processing instructed by the processing execution instruction. Here, a case where the master node 10 sends the distribution processing 81 to the worker node 30B including the protection region 61 and the FPGA 62 as operation resources will be described. The distribution processing 81 corresponds to the processing instructed by the processing execution instruction. Here, the description will be given on a case where the distribution processing 81 includes processing 81a to be performed in the protection region and processing 81b to be performed in the FPGA.

In the worker node 30B, the processing reception unit 33 receives the distribution processing 81 sent from the master node 10 and causes the processing execution unit 60 to execute the distribution processing 81. In the processing execution unit 60, the protection region 61 executes the processing 81a which is to be performed in the protection region, and the FPGA 62 executes the processing 81b which is to be performed in the FPGA.

Here, if the distribution processing 81 sent from the master node 10 to the worker node 30B is excessively increased, the worker node 30B requests another worker node capable of providing operation resources to share a part of the processing. At that time, the device information confirmation unit 35 in the worker node 30B confirms the operation resource of the other worker nodes based on the device information 46 (FIGS. 1 and 2) of the other worker nodes shared in advance, and selects at least one of the other worker nodes that provide the operation resource. Here, the description will be given on a case where the worker node 30B has completed the execution of the processing in the FPGA 62 but has not completed the execution of the processing in the protection region 61 and requests the worker node 30C including the protection region 61 to share the incomplete processing. Therefore, here, the description will be given on a case where the worker node 30B selects the worker node 30C as another worker node capable of providing the operation resource.

In this case, the processing sharing request unit 36 in the worker node 30B sends the processing sharing request 84 to the worker node 30C. The processing sharing request 84 requests another worker node to share the incomplete processing. The processing sharing request 84 includes the information regarding the completed processing 82 (for example, an execution result of processing in the FPGA 62) and the information regarding the incomplete processing 83 (for example, contents of incomplete processing in the protection region 61).

Further, the processing transmission unit 37 in the worker node 30B transmits the processing sharing request notification 85 to the master node 10. The processing sharing request notification 85 notifies the master node 10 that another worker node has been requested to share the incomplete processing. In the master node 10, the processing result reception unit 18 receives the processing sharing request notification 85. Thus, the master node 10 can recognize that the execution result of the processing distributed to the worker node 30B will be sent from the worker node 30C.

The worker node 30 (here, the worker node 30C) that has been requested to share the incomplete processing executes the requested incomplete processing 83 (processing to be performed in the protection region). When the execution of the requested processing is completed, the worker node 30C sends the completion of distributed processing 87 to the master node 10. The completion of distributed processing 87 is an execution result of the distribution processing 81 transmitted from the master node 10 to the worker node 30B. The completion of distributed processing 87 includes the information regarding the completed processing 82 executed by the worker node 30B and information regarding completed processing 88 executed by the worker node 30C. The information regarding the completed processing 82 is, for example, an execution result of processing in the FPGA 62 of the worker node 30B. The information regarding the completed processing 88 is, for example, an execution result of processing in the protection region 61 of the worker node 30C itself. The master node 10 that has received the completion of distributed processing 87 sends the processing execution result to the terminal device (transmission source of the processing execution instruction) of the user based on the completion of distributed processing 87.

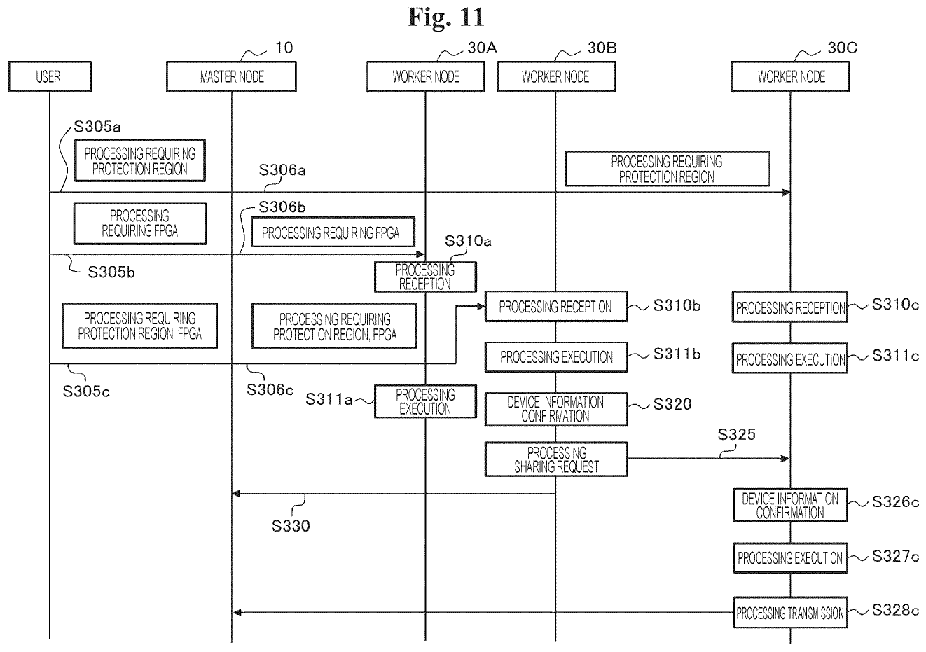

As illustrated in FIG. 11, the distributed processing system 100 operates as follows when performing processing distribution. FIG. 11 is a sequence diagram explaining the processing distribution performed in the distributed processing system 100.

At the time of processing distribution, the instruction reception unit 16 in the master node 10 receives “processing that needs a protection region” from the terminal device of the user at any timing (step S305a).

After step S305a, the processing distribution unit 17 in the master node 10 distributes the “processing that needs a protection region” to the worker node 30C including the protection region 61 (step S306a). In the worker node 30C, the processing reception unit 33 receives “processing that needs a protection region” (step S310c), and the protection region 61 executes the “processing that needs a protection region” (step S311c).

Further, at the time of processing distribution, the instruction reception unit 16 in the master node 10 receives “processing that needs FPGA” from the terminal device of the user at any timing (step S305b). The processing distribution unit 17 in the master node 10 distributes the “processing that needs FPGA” to the worker node 30A including the FPGA 62 (step S306b). In the worker node 30A, the processing reception unit 33 receives the “processing that needs FPGA” (step S310a), and the FPGA 62 executes the “processing that needs FPGA” (step S311a).

Furthermore, at the time of processing distribution, the instruction reception unit 16 of the master node 10 receives “processing that needs a protection region and/or FPGA” from the terminal device of the user at any timing (step S305c). The processing distribution unit 17 in the master node 10 distributes the “processing that needs a protection region and/or FPGA” to the worker node 30B including the protection region 61 and the FPGA 62 (step S306c). In the worker node 30B, the processing reception unit 33 receives the “processing that needs a protection region and/or FPGA” (step S310b), and the FPGA 62 executes the “processing that needs FPGA” (step S311b). Here, the description will be given on a case where only the processing using the FPGA 62 is executed in step S311b as a result of an excessive increase in the distribution processing 81 sent from the master node 10 to the worker node 30B. That is, here, the execution of the processing in the FPGA 62 has been completed but the execution of the processing in the protection region 61 has not been completed.

After step S311b, the device information confirmation unit 35 in the worker node 30B takes a look on the operation resources (i.e. the device information of the protection region of the worker node 30C) of other worker nodes based on the device information 46 (FIGS. 1 and 2) of the other worker nodes shared in advance (step S320), and selects another worker node (here, the worker node 30C) that can provide the operation resources. That is, when the memory used in the protection region or the memory used in the FPGA is full with respect to the distribution of the device dependent processing, each worker node 30 shares the incomplete processing using the memory of the other worker nodes. Note that the sharing destination of the incomplete processing (distribution destination of the processing) may be determined based on priority order information transmitted in advance by the master node 10 to each worker node 30. For example, the priority order may be set in descending order of the capacity that is determined by the device information.

After step S320, the processing sharing request unit 36 in the worker node 30B sends the processing sharing request 84 to the worker node 30C (step S325). The processing sharing request 84 includes authentication information of the worker node 30B. Note that, if all the capacities of the sharing destination (processing distribution destination) of the incomplete processing are full, processing is waited for to be executed in the worker nodes. Further, the processing transmission unit 37 transmits the processing sharing request notification 85 to the master node 10 (step S330).

After step S325, the device information confirmation unit 35 in the worker node 30C confirms the authentication information of the worker node 30B included in the processing sharing request 84 (step S326c), and executes the incomplete processing (processing using the protection region 61) requested in the processing sharing request 84 when the authentication information is confirmed (step S327c). When the execution of the requested incomplete processing is completed, the processing transmission unit 37 transmits the completion of distributed processing 87 to the master node 10 (step S328c).

### Hardware Configuration

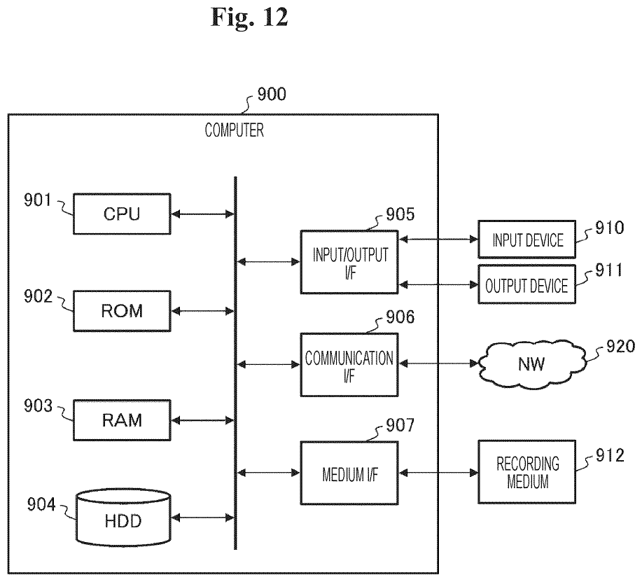

The master node 10 and the worker node 30 of the distributed processing system 100 according to the present embodiment are implemented by a computer 900 having a configuration as illustrated in FIG. 12, for example. FIG. 12 is a hardware configuration diagram illustrating an example of a computer 900 that implements the functions of the master node 10 and the worker node 30 according to the present embodiment. The computer 900 includes a central processing unit (CPU) 901, a read only memory (ROM) 902, a RAM 903, a hard disk drive (HDD) 904, an input/output interface (I/F) 905, a communication I/F 906, and a medium I/F 907.

The CPU 901 operates based on a program stored in the ROM 902 or the HDD 904, and performs control by the control units 11 and 31 (FIG. 1). The ROM 902 stores a boot program to be executed by the CPU 901 when the computer 900 is started, a program related to the hardware of the computer 900, and the like.

The CPU 901 controls an input device 910 such as a mouse or a keyboard and an output device 911 such as a display or a printer via the input/output I/F 905. The CPU 901 acquires data from the input device 910 and outputs generated data to the output device 911 via the input/output I/F 905. Note that the input/output I/F 905 corresponds to an input unit and an output unit of the master node 10 and the worker node 30.

The HDD 904 stores a program to be executed by the CPU 901, data to be used by the program, and the like. The communication I/F 906 receives data from another device via a communication network (for example, network (NW) 920), outputs the data to the CPU 901, and transmits data generated by the CPU 901 to the another device via the communication network. Note that the communication I/F 906 corresponds to a communication unit between the master node 10 and the worker node 30.

The medium I/F 907 reads a program or data stored in a recording medium 912, and outputs the program or data to the CPU 901 via the RAM 903. The CPU 901 loads a program related to target processing from the recording medium 912 onto the RAM 903 via the medium I/F 907, and executes the loaded program. The recording medium 912 is an optical recording medium such as a digital versatile disc (DVD) or a phase change rewritable disk (PD), a magneto-optical recording medium such as a magneto optical disk (MO), a magnetic recording medium, a semiconductor memory, or the like.

For example, in a case where the computer 900 functions as the master node 10 and the worker node 30 of the present invention, the CPU 901 of the computer 900 implements the functions of the master node 10 and the worker node 30 by executing a program loaded on the RAM 903. Further, data in the RAM 903 is stored in the HDD 904. The CPU 901 reads the program related to the target processing from the recording medium 912 and executes the program. Additionally, the CPU 901 may read the program related to the target processing from other devices via the communication network (NW 920).

### Effects

Hereinafter, the effects of the distributed processing system 100 according to the present invention will be described.

(1) As illustrated in FIG. 1, the distributed processing system 100 according to the present embodiment includes at least one master node 10 and a plurality of worker nodes 30A, 30B, and 30C including operation resources for executing processing according to an instruction of the master node 10. The master node 10 includes a device information collection unit 13 that collects device information of each of the worker nodes 30A, 30B, and 30C, a device information transmission unit 15 that transmits to at least one of the plurality of worker nodes 30A, 30B, and 30C device information of the other worker nodes, and a processing distribution unit 17 that distributes processing to one or more than one of the plurality of worker nodes 30A, 30B, and 30C. The worker node 30 includes a processing execution unit 60 that executes processing distributed from the master node 10, and a processing sharing request unit 36 that requests at least one of the worker nodes including the same type of an operation resource (protection region 61, FPGA 62, or the like) to share the processing based on the device information of the other worker nodes when the processing distributed from the master node 10 is excessively increased.

With this configuration, the distributed processing system 100 according to the present invention performs device authentication of the worker nodes 30A, 30B, and 30C in advance in the master node 10, sharing of device information in advance among the worker nodes 30A, 30B, and 30C, and aggregation of information in the master node 10. Thus, the distributed processing system 100 can confirm the authenticity of the protection region 61 and the FPGA 62 in the worker nodes 30 as the processing division destination. In addition, when the processing is biased to the worker node 30 (in the illustrated example, the worker node 30B) having many functions, that is, when the processing distributed from the master node 10 to the worker node 30B is excessively increased, the distributed processing system 100 can divide a part of the processing to the worker node (in the illustrated example, the worker node 30C) having a smaller number of functions. As a result, the distributed processing system 100 can reduce the bias of the processing allocation to the plurality of worker nodes 30.

(2) As illustrated in FIG. 5, in the distributed processing system 100 described in (1), the worker nodes 30A, 30B, and 30C may each include a storage unit 41 that stores a certificate and key information, and the master node 10 may include a memory in a storage unit 21 that stores the certificate stored in the worker nodes 30A, 30B, and 30C and key information.

With this configuration, the distributed processing system 100 can perform device authentication of the worker nodes 30A, 30B, and 30C in advance in the master node 10, sharing of device information in advance among the worker nodes 30A, 30B, and 30C, and aggregation of information in the master node 10.

(3) As illustrated in FIGS. 2 and 5, in the distributed processing system 100 described in (1), the device information of the other worker nodes transmitted from the master node 10 to each of the worker nodes 30 may include information of the operation resource of the other worker nodes and information of a protection region of the other worker nodes.

With this configuration, the distributed processing system 100 can request another worker node to share a part of the processing distributed from the master node 10 by sharing the device information in advance among the worker nodes 30A, 30B, and 30C.

(4) As illustrated in FIG. 5, in the distributed processing system 100 described in (1), the worker nodes 30 may each store in the storage unit 41, an ID, a public key, and a secret key allocated to an operation resource included in the worker node itself as the device information. The worker nodes 30 may further include a device information confirmation unit 35 that confirms authenticity of other worker nodes based on the device information of the other worker nodes.

With this configuration, the distributed processing system 100 can confirm authenticity of worker nodes.

(5) In the distributed processing system 100 described in (1), the processing distribution unit 17 in the master node 10 may distribute processing in such a manner that processing is completed in each of the worker nodes 30 based on the device information of each of the worker nodes 30 collected by the device information collection unit 13 according to a processing execution instruction received from an outside.

With this configuration, the distributed processing system 100 can distribute the processing so that the master node 10 completes the processing in each worker node 30.

(6) In the distributed processing system 100 described in (1), if the processing distributed from the master node 10 is excessively increased, the worker node 30 may confirm authenticity of the other worker nodes based on a certificate included in the device information of the other worker nodes, and may request one or more than one of the worker nodes including the same type of an operation resource to share the processing.

With this configuration, the distributed processing system 100 can request another worker node to share a part of the processing distribution from the master node 10. Note that the present invention is not limited to the above-described embodiment, and many modifications can be made by those skilled in the art within the technical idea of the present invention.

For example, the processing execution unit 60 is not limited to the protection region 61 and the FPGA 62, and may be another operation resource such as a GPU.

### REFERENCE SIGNS LIST

10 Master node (server)
11 Control unit
12 Authentication information transmission unit
13 Device information collection unit
14 Device information confirmation unit
15 Device information transmission unit
16 Instruction reception unit
17 Processing distribution unit
18 Processing result reception unit
21 Storage unit
22 ID
23 Secret key
24 Public key
25 Certificate Information
26 Collected device information
30, 30A, 30B, 30C Worker node (server)
31 Control unit
32 Authentication information notification unit
33 Processing reception unit
34 Device information notification unit
35 Device information confirmation unit
36 Processing sharing request unit
37 Processing transmission unit
41 Storage unit
42 ID
43 Secret key
44 Public key
45 Device information
46 Device information
60 Processing execution unit
61 Protection region (operation resource)
62 FPGA (operation resource)
71 Random number
72 Signature
73 Public key
74 Device information
81 Distribution processing
81a Processing in protection region
81b Processing in FPGA
82 Completion processing (processing in FPGA)
83 Incomplete processing (processing in protection region)
84 Processing sharing request
85 Processing sharing request notification
86 Completion of sharing-requested processing (processing in protection region)
87 Completion of distributed processing
88 Completed processing (processing in protection region)
100 Distributed processing system
900 Computer
901 CPU
902 ROM
903 RAM
904 HDD
905 Input/output I/F
906 Communication I/F
907 Medium I/F
910 Input device
911 Output device
912 Recording medium
920 NW
AP10 Control program
AP30 Control program

1. A distributed processing system comprising:
at least one master node; and
a plurality of worker nodes including operation resources for executing processing according to an instruction of the master node, wherein
the master node includes
a device information collection unit that collects device information of each of the worker nodes,
a device information transmission unit that transmits to at least one of the plurality of worker nodes device information of the other worker nodes, and
a processing distribution unit that distributes processing to at least one of the plurality of worker nodes, and
the worker nodes each include
a processing execution unit that executes processing distributed from the master node, and
a processing sharing request unit that requests at least one of the worker nodes including a same type of an operation resource to share the processing based on the device information of the other worker nodes when the processing distributed from the master node is excessively increased.

2. The distributed processing system according to claim 1, wherein
the worker nodes each include a storage unit that stores a certificate and key information, and
the master node includes a storage unit that stores the certificate and the key information stored in the worker nodes.

3. The distributed processing system according to claim 1, wherein
the device information of the worker nodes transmitted from the master node to each of the worker nodes includes information of the operation resource of the other worker nodes and information of a protection region of the other worker nodes.

4. The distributed processing system according to claim 1, wherein
the worker nodes each
store, in a storage unit, an ID, a public key, and a secret key allocated to an operation resource included in the worker node itself as the device information, and
further include a device information confirmation unit that confirms authenticity of the other worker nodes based on the device information of the other worker nodes.

5. The distributed processing system according to claim 1, wherein
the processing distribution unit in the master node distributes processing based on the device information of each of the worker nodes collected by the device information collection unit in such a manner that processing is completed in each of the worker nodes according to a processing execution instruction received from an outside.

6. The distributed processing system according to claim 1, wherein
when the processing distributed from the master node is excessively increased, the worker node confirms authenticity of the other worker nodes based on a certificate included in the device information of the other worker nodes, and requests at least one of the other worker nodes including a same type of the operation resource to share the processing.

7. A method implemented by a computer including a central processing unit that functions as a master node and a plurality of computers each including a central processing unit that function as worker nodes, the method comprising:
allowing the central processing unit of the computer functioning as the master node to collect device information of each of the worker nodes;
allowing the central processing unit of the computer functioning as the master node to transmit to at least one of the plurality of worker nodes device information of the other worker nodes;
allowing the central processing unit of the computer functioning as the master node to distribute processing to at least one of the plurality of worker nodes;
allowing the central processing unit of the computer functioning as the at least one of the plurality of the worker nodes to execute the processing distributed from the master node; and
allowing the central processing unit of the computer functioning as the at least one of the plurality of the worker nodes to request at least one of the other worker nodes including a same type of an operation resource to share the processing based on the device information of the other worker nodes when the processing distributed from the master node is excessively increased.

8. A computer readable medium storing a program for causing a computer including a central processing unit to function as a master node that instructs a worker node to execute processing, the program causing the central processing unit of the computer to:
collect device information of each of worker nodes;
transmit device information of the worker nodes to a worker node including a same type of an operation resource based on the collected device information; and
distribute the processing to any of the worker nodes.

9. A program for causing a computer to function as a worker node that executes processing according to an instruction of a master node, the program causing the computer to:
execute the processing distributed from the master node; and
request at least one of the other worker nodes including a same type of an operation resource to share the processing based on device information of the other worker nodes transmitted from the master node when the processing distributed from the master node is excessively increased.
